(19) United States
(12) Patent Application Publication
(10) Pub. No.: US 2011/0187124 A1
(43) Pub. Date: Aug. 4, 2011

(54) POWER GENERATING APPARATUS AND PROCESS

(76) Inventor: Miro Milinkovic, Acton (CA)

(21) Appl. No.: 12/999,901

(22) PCT Filed: Jun. 19, 2009
(86) PCT No.: PCT/CA09/00868

§ 371 Date: Mar. 8, 2011

(30) Foreign Application Priority Data
Jun. 20, 2008 (CA) 2635493

(51) Int. Cl. H02K 7/18; H02K 35/00; F03G 7/06

(52) U.S. Cl. 290/1 A

(57) ABSTRACT

Apparatus and process for generating an electric output comprising (a) electromagnetic means having magnet means and electromagnetic coil means; (i) a plurality of gas receiving chambers comprising at least a first chamber and a second chamber; each of the chambers having gas inlet and outlet means and adapted to receive and expel pressurized gas; (ii) moveable member means associated with the chambers; (b). means for providing pressurized gas to the chambers; (c) means for releasing pressurized gas from the chambers; and (d) means for providing timing and synchronized control of pressurized gas into and out of the chambers to effect movement of the moveable member means to provide the electric output. The apparatus and process allows for the efficient utilization of low grade heat, for example, from geothermal, waste cooling fluids and other types of waste heat sources.

### FIELD OF THE INVENTION

This invention relates to the production of electric current by electromagnetic generation means, particularly a linear generator, from a pressurized gas provided particularly from a low grade heat source.

### BACKGROUND OF THE INVENTION

Utilization of so-called low grade heat, for example, from cooling processes carried out in heat transfer equipment is minimal. Traditional so-called waste heat recovery systems are generally based on the Rankine cycle involving turbine-generator to provide power.

Similar systems have been used to cooperate power from geothermal water sources.

However, there is a need for improved apparatus and processes of generating electricity from such relatively low heat sources.

### BRIEF SUMMARY OF THE INVENTION

The present invention generally comprises a generator configured for generating electrical energy utilizing low grade heat or waste heat.

In one aspect, the invention provides an apparatus for generating an electric current comprising

(a) electromagnetic means having
(i) a plurality of gas receiving chambers comprising at least a first chamber and a second chamber; each of said chambers having gas inlet and outlet means and adapted to receive and expel pressurized gas
(ii) moveable member means associated with said chambers;

(b) means for providing pressurized gas to said chambers;

(c) means for releasing pressurized gas from said chambers; and

(d) means for providing timing and synchronized control of pressurized gas into and out of said chambers to effect movement of said moveable member means to provide said electric current.

In one aspect, the invention provides an apparatus for electrical power generation comprising
(A) linear generator means comprising
   a housing;
   a reciprocatable piston having a first end face and a second end face within said housing; said housing having

(i) a first portion, which with said piston first end face defines a first chamber; and

(ii) a second portion, which with said piston second end face defines a second chamber;

magnet means and electromagnetic coil means cooperable with said piston and said magnet means whereby operable reciprocatable movement of said piston effects generation of electric current in said electromagnetic coil means; wherein said first chamber has first gas first inlet and outlet means; and said second chamber has second gas second inlet and outlet means;
(B) first valve means to operably control passage of feed said first gas through said first inlet into said first chamber and spent first gas through said first outlet out of said chamber;
(C) second valve means to operably control passage of feed said second gas through said second inlet into said second chamber and spent second gas through said second outlet out of said chamber; wherein said first valve means is adapted to receive said feed first gas and said second valve means is adapted to receive said feed second gas.

The apparatus as hereinabove defined according to embodiments has said first gas first inlet and outlet means comprising first inlet means and distinct first outlet means, and said second gas second inlet and outlet means comprising second inlet means and distinct second outlet means.

In a further embodiment, the invention provides an apparatus as hereinabove defined wherein said first valve means comprises feed said first gas valve means and distinct spent first gas valve means; and said second valve means comprises feed said second gas valve means and distinct spent second gas valve means.

The magnet means comprises piston magnet means wherein said piston magnet means comprises magnet means affixed to said piston.

In a further embodiment the piston. is formed in whole or in part of a magnetic material.

In a further embodiment the housing is formed in whole or in part of a magnetic material.

In a further embodiment the housing is affixed or adjacent magnet means.

In a further embodiment the electromagnetic coil means is adjacent said housing.

In a further embodiment the electromagnetic coil means is adjacent said piston.

The piston comprises said electromagnetic coil means.

According to an embodiment, the feed first gas and said feed second gas are common

According to an embodiment, the invention provides an apparatus as hereinabove defined further comprising heat exchanger means comprising; means for feeding a heat-source fluid to said heat exchanger means; means for feeding a heat-receiving fluid to said heat exchange to operably effect heat exchange with said heat-source fluid to produce a pressurized heated gas comprising a gas selected from the group consisting of said feed first gas, said feed second gas and combinations, thereof.

While gas at high pressures is of value in the practice of the invention, relatively low pressures of 80 psi to 150 psi are also valuable.

According to an embodiment, the invention provides an apparatus comprising synchronization control means wherein said first valve means and second valve means are synchronized to operably effect simultaneous first valve means opening with said second valve means closing, alternately, with first valve means closing with second valve means opening to effect continuous reciprocating piston movement cycles.

According to an embodiment, the synchronization control means comprises CPU control means operating under stored program or software control.

According to an embodiment, the apparatus comprises a plurality of linear generator means in parallel or series.

In an alternative embodiment, the invention provides an apparatus for electrical power generation comprising a housing having a cylindrical wall and a central longitudinal axis; a plurality of radial vanes within said housing operably rotatable around said central axis; said vanes with said wall define a plurality of chambers wherein each chamber has a wall portion; gas inlet and outlet means within each of said wall portions; valve means cooperable with each of said gas inlet and outlet means to operably control passage of a feed gas through each of said inlets into each of said chambers and spent gas through each of said gas outlets out of each of said chambers; magnet means and electromagnetic coil means cooperable with said vanes whereby operable rotary movement of said vanes effects generation of electric current in said electromagnetic coil means.

In an embodiment the invention provides an apparatus as hereinabove defined wherein each of said gas inlet and outlet means comprise inlet means and distinct outlet means.

In a further embodiment the invention provides an apparatus as hereinabove defined wherein said valve means comprises feed gas valve means and distinct spent gas valve means.

In yet a further aspect, the invention provides a method for producing an electric current by electromagnetic means comprising a plurality of chambers having gas inlet and outlet means; said method comprising
(a) (i) feeding a first pressurized gas to a first chamber of said electromagnetic means to provide a first pressure within said first chamber;
   (ii) synchronized releasing of a second pressurized gas from a second chamber to effect movement of said moveable member means to provide an electric current;
(b) (i) feeding a third pressurized gas to said second chamber of said electromagnetic means to provide said second pressure within said second chamber;
   (ii) synchronized releasing of said pressurized gas from said first chamber to effect movement of said moveable member means to provide an electric current; and
(c) subsequently repeating steps (a) and (b) to provide continuous electric current.

### BRIEF DESCRIPTION OF THE DRAWINGS

In order that the invention may be better understood, embodiments will now be described, by way of example only, with reference to the accompanying drawings wherein

FIGS. 1 and 2 represents schematic diagrams of apparatus and processes according to embodiments of the present invention;

FIG. 3 represents a schematic diagrammatic longitudinal cross-section of a linear generator according to an embodiment of the present invention;

FIG. 4 represents schematic diagram of a plurality of linear generators arranged in parallel according to an embodiment of the present invention.

In the drawings, like numerals or references indicate like elements or parts.

### DETAILED DESCRIPTION OF THE EMBODIMENTS

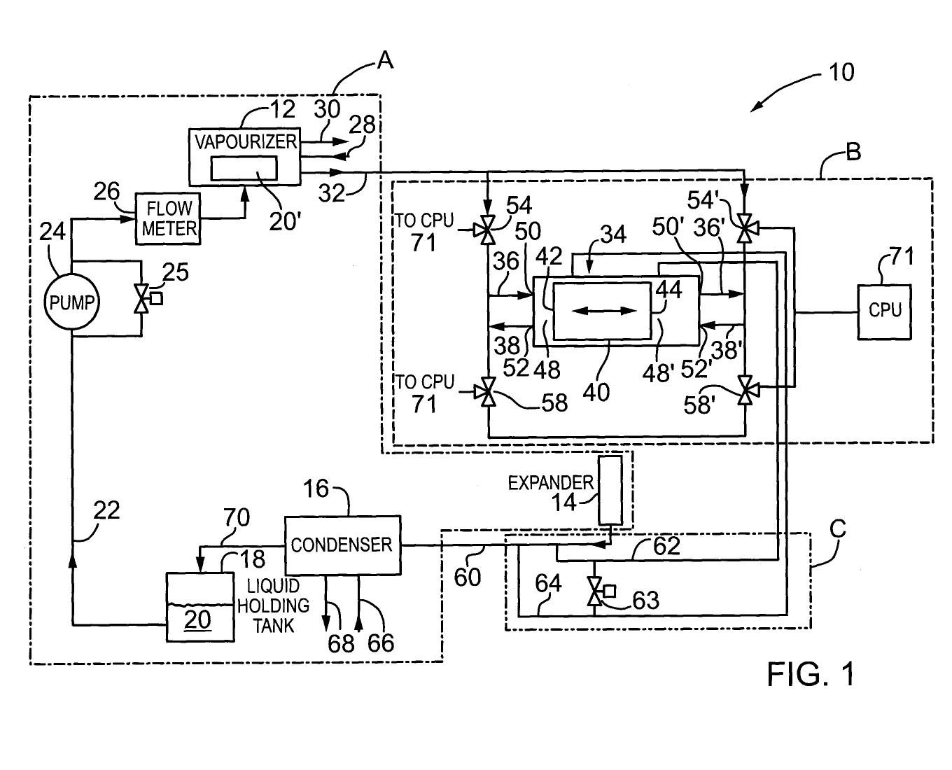

Reference is first made to FIG. 1, which shows an apparatus according to the invention and indicated generally by reference 10. According to an embodiment, the apparatus 10 comprises three modules or interconnected circuits denoted by dotted lines “A”, “B” and “C”.

Circuit A comprises a self-contained vapour-liquid heat transfer and force generating circuit, Circuit B comprises an electromagnetic linear generator for producing electric current, and Circuit C comprises a magnet cooling system.

According to an embodiment, Circuit A comprises a vaporizer 12, expander 14 condenser 16, liquid reservoir 18 linked through gaseous and liquid conduits and valves as hereinafter described.

Reservoir 18 acts as a holding tank for a fluid or condensate 20, such as a suitable Freon gas, and is connected by conduit 22 through high pressure pump 24 and flow meter 26 to a vaporizer 12, for example, configured as a shell and tube heat exchanger vaporizer. Vaporizer 12 has a heat fluid inlet conduit 28, a fluid outlet conduit 30, and gaseous outlet 32. According to an embodiment, the heat fluid inlet conduit 28 is coupled to a low grade or waste heat source and the low grade heated fluid is utilized by the vaporizer 12 to convert the fluid or condensate 20 into a gas or vapor, which is outputted on the gaseous outlet 32 and used to generate forces utilized by the linear generator 34 as described in more detail below.

According to an embodiment, the pressure pump 24 comprises a high pressure pump and is configured with a pump bypass valve 25. According to one aspect, the pump bypass valve 25 is configured to adjust the flow of condensate from the reservoir 18, the condensate supply pressure, or both, to the vaporizer 12. According to another aspect, the pressure pump 24 is configured to be responsive to a control signal from a processor or CPU 71 (operating under stored program control) for adjusting/varying the operation of the pump 24, for example, the RPM of the pump 24, and the flow of the condensate is adjusted using the pump bypass valve 25, for example, the pump bypass valve 25 is configured with a manually adjustable needle valve.

With reference to FIG. 1, Circuit “B” comprises a linear generator indicated generally by reference 34. According to an embodiment, the linear generator 34 includes a pair of associated gaseous inlet and outlet conduits 36, 38 and 36′ and 38′.

Linear generator 34 comprises a piston 40 having a first end face 42 and a second end face 44 within a housing 46. According to embodiment, the piston 40 is configured for reciprocating linear movement within the generator 34. Housing 46 and end face 42 define a first chamber 48, and housing 46 and end face 44 define a second chamber indicated generally by reference 48′. Housing 46 has an inlet 50 and outlet 52 for first chamber 48, and an inlet 50′ and outlet 52′ for second chamber 48′.

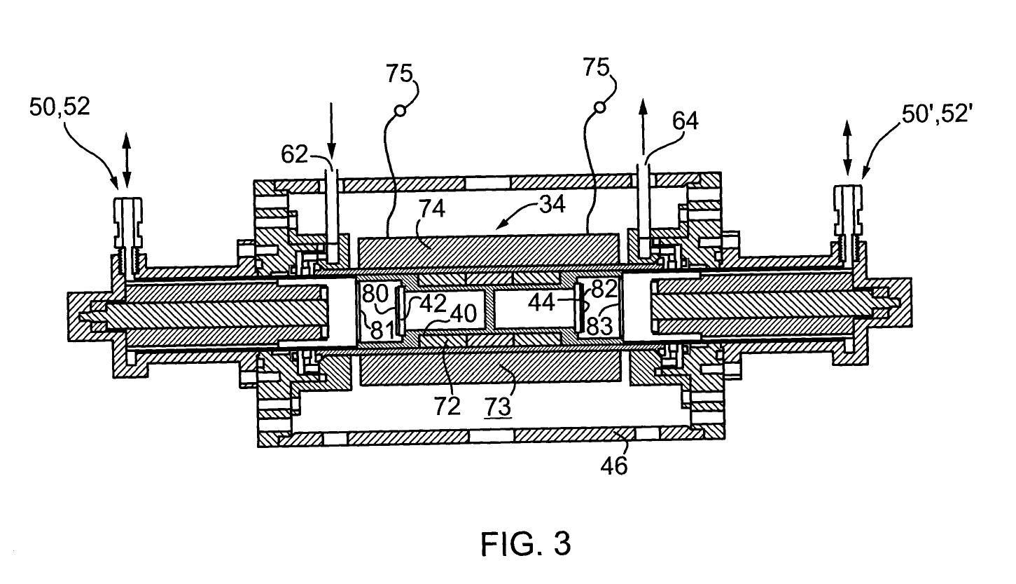

The linear generator 34 is shown in greater detail in FIG. 3 and described below.

As part of Circuit A, conduit 32 is in communication with first chamber 48 through inlet 50 under the control of valve 54, and with second chamber 48′ through inlet 50′ under the control of valve 54′.

Conduit 56 is in communication with first chamber 48 through outlet 52 and expands 14 under the control of valve 58. Conduit 56′ is in communication with second chamber 48′ through outlet 52′ and expander 14 under the control of valve 58′.

According to an embodiment, the control valves 54, 58, 54′, 58 comprise controllable values that are configured to be responsive to one or more control signals for actuating the valve. According to an embodiment, a controller 71, e.g. a central processing unit or processor, is provided that is operatively coupled to the control valves and other controllable components and configured to operate under stored program control (e.g. execute instructions or executable code in the form of firmware or software stored in memory) to provide the functionality as described.

Expander 14 is connected to condenser 16 by conduit 60 and magnet cooling Circuit “C” by feed and return conduits 62 and 64, respectively.

Condenser 16 has heat exchanger cooling fluid input conduit 66, an output conduit 68, and liquid transfer conduit 70 to reservoir 20.

Circuit “C” comprises conduit lines 62 and 64 and is configured to provide cooling of the permanent magnets 72 of linear generator 34 shown in FIG. 3. According to an embodiment, the cooling circuit C is configured to circulate coolant around the magnets in the linear generator 34 and may include a pump and a bypass valve 63 for flow control.

In operation, and according to an exemplary embodiment, vaporizer 12 receives low grade heat transfer fluid at a temperature of about 90° C. from, for example, a chemical plant process, waste heat source, and/or power utilities through conduit 28 for heat exchange with liquid 20 to generate pressurized Freon gas Freon 20′ at a typical P₁ pressure of 65 psi and 85° C. in this embodiment.

With valves 54 and 58′ open and valves 54′ and 58 closed, gas 20′ enters first chamber 48 through inlet 50 to raise the pressure in and expansion of first chamber 48 to P₁ to produce linear movement of piston 40 and expulsion of gas 20′ out of chamber 48′ through conduit 52′ and valve 58′ to expander 14 and reduction in pressure of P₁ of about 25 psi. According to one aspect, the valves 54, 54′ and 58,58′ are configured as flow switches to allow pressure forces from the vaporizer 12 to act on the piston 40 (i.e. move the piston 40) and allow vapour exhaust from the chambers 48, 48′ to be removed or exhausted. The vapour exhaust is captured by the expander 14 and directed to the condenser 16 where it is condensed into liquid form and drained to the holding tank 18. According to an embodiment, the holding tank 18 is configured with a window or other mechanism to allow determining the level of the condensate.

Linear movement of magnet(s) 72 on loaded piston 40 with respect to permanent magnets 73 affects production of electric current in a coil 74, for example, as depicted in FIG. 3.

Synchronized closing of valves 54 and 58′ and opening of valves 58 and 54′ causes expansion of chamber 48′ with pressure increase to P₁ and return movement of piston 40 and generation of further electric current. Such reciprocating movement of piston 40 from the timed or synchronized opening and closing of the double paired valves, as described above, results in the controlled production of an electrical output, e.g. pulses.

According to an embodiment, the valve synchronization and timing or sequenced operation is controlled by CPU 71 operating under stored program control (e.g. executing instructions in firmware or software stored in memory. According to an embodiment, the CPU 71 is configured to monitor and/or control the following parameters or variables, temperature, pressure, pump speed (e.g. RPM), piston frequency, voltage and current.

Reference is made again to FIG. 3, which shows linear generator 34 according to an embodiment of the invention. As shown, the linear generator 34 comprises housing 46 enclosing piston 40 having end face 42 and 44, and further includes gas inlets and outlets 50, 50′ and 52, 52′, respectively, and is connected through coil leads 75 to an electric current receiver (for example, a storage device such as a capacitor with a diode gate) embraces housing 46. Piston 40 has a plurality of affixed permanent magnets 76.

According to an embodiment, two disc shaped permanent magnets 80, 81 of opposite polarity are positioned at the first end face 42 of the piston 40 and at the end face of the housing 26 cylinder so as to generate a repulsive force working on the first end face 42 of the piston 40 to avoid that the piston 40 touches end face of the housing cylinder 26. Similarly, two disc shaped permanent magnets 82, 83 of opposite polarity are positioned at the second end face 44 of the piston 40 and at the end face of the housing cylinder 26 so as to generate a repulsive force working on the second end face 44 of the piston 40 so that the piston avoids touching or contacting end face of the housing cylinder 26, i.e. when the piston 40 reaches the end of its stroke, the magnet 80 or 82 is repelled by the respective magnet 81 or 83 and force is generated to push back the piston 40. According to an embodiment the magnets 80,81 and 82,83 comprise rare earth type magnets. The pressure difference between the vaporizer 12 and the condenser 16 results in a force which acts to move the piston 40 in the linear generator 10. It will be appreciated that the frequency of operation for the piston 40 depends on the mass and/or geometry of the piston 40, the resulting force generated, and/or the rebounding forces generated by the repulsive forces of the magnets 80,81 and 82,83.

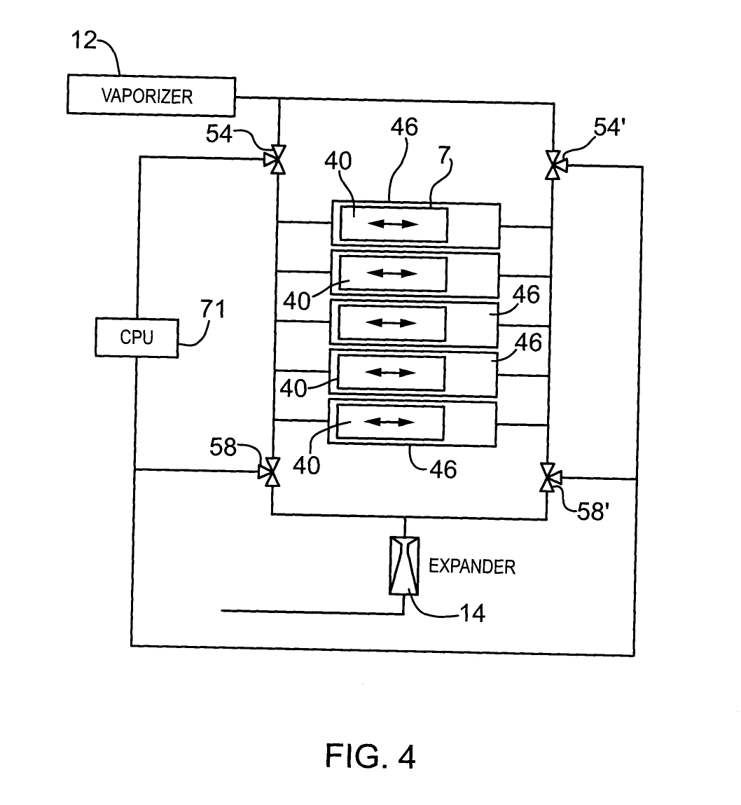

FIG. 4 shows generally in part a plurality of linear generators arranged in parallel, under the control of valves 54, 54′ and 58, 58′.

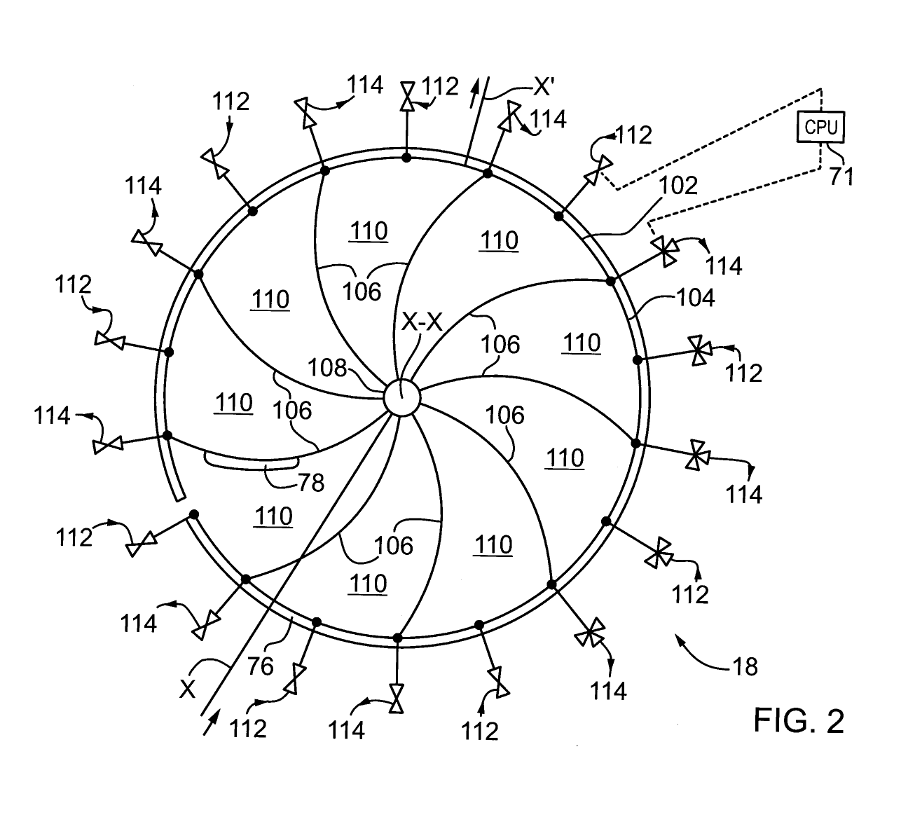

Reference is lastly made to FIG. 2, which shows a generator according to another embodiment and indicated generally by reference 100. As shown, the generator 100 comprises a housing 102 having a cylindrical wall 104 and a central longitudinal axis X-X′.

Within housing 102 is arranged a plurality of vanes 106 affixed to central longitudinal rotatable axle 108. Vanes 106 with portions of wall 104 define a plurality of chambers 110.

Each of wall portions has an inlet 112 and outlet 114 to receive and release pressurized gas under the control of valves 116 and 118, respectively.

Pressurized gas P₁ for example, through conduits 32 produced by vaporizer 12 as hereinabove described with reference to FIG. 1 alternately enter or leaves chambers 110 in a synchronized manner under the control of valves 112 and 114 and CPU 71.

Conduit coil 76 of electromagnetic system is affected around housing and generates electric current by rotation of magnets 78 affixed to vanes 106.

Although this disclosure has described and illustrated certain embodiments of the invention, it is to be understood that the invention is not restricted to those particular embodiments. Rather, the invention includes all embodiments which are functional or mechanical equivalence of the specific embodiments and features that have been described and illustrated.

1. An apparatus for generating an electric current comprising
(a) electromagnetic means having magnet means and electromagnetic coil means;
(i) a plurality of gas receiving chambers comprising at least a first chamber and a second chamber; each of said chambers having gas inlet and outlet means and adapted to receive and expel pressurized gas
(ii) movable member means associated with said chambers;
(b) means for providing pressurized gas from said chambers;
(c) means for releasing pressurized gas from said chambers; and
(d) means for providing timing and synchronized control of pressurized gas into and out of said chambers to effect movement of said moveable member means to provide said electric current.

2. The apparatus for electrical power generation as claimed in claim 1 comprising
(A) linear generator means comprising
a housing;
a reciprocatable piston having a first end face and a second end face within said housing; said housing having
(i) a first portion, which with said piston first end face defines a first chamber; and
(ii) a second portion, which with said piston second end face defines a second chamber;
magnet means and electromagnetic coil means cooperable with said piston and said magnet means whereby operable reciprocatable movement of said piston effects generation of electric current in said electromagnetic coil means; wherein said first chamber has first gas first inlet and outlet means; and said second chamber has second gas second inlet and outlet means;
(B) first valve means to operably control passage of feed said first gas through said first inlet into said first chamber and spent first gas through said first outlet out of said chamber;
(C) second valve means to operably control passage of feed said second gas through said second inlet into said second chamber and spent second gas through said second outlet out of said chamber; wherein said first valve means is adapted to receive said feed first gas and said second valve means is adapted to receive said feed second gas.

3. The apparatus as claimed in claim 1 wherein said first gas first inlet and outlet means comprises first inlet means and distinct first outlet means.

4. The apparatus as claimed in claim 3 wherein said second gas second inlet and outlet means comprises second inlet means and distinct second outlet means.

5. The apparatus as claimed in claim 4 wherein said first valve means comprises feed said first gas valve means and distinct spent first gas valve means.

6. The apparatus as claimed in claim 5 wherein .said second valve means comprises feed said second gas valve means and distinct spent second gas valve means.

7. The apparatus as claimed in claim 6 wherein said magnet means comprises piston magnet means.

8. The apparatus as claimed in claim 7 wherein said piston magnet means comprises magnets means affixed to said piston.

9. The apparatus as claimed in claim 8 wherein said piston is formed in whole or in part of a magnetic material.

10. The apparatus as claimed in claim 9 wherein said housing is formed in whole or in part of a magnetic material.

11. The apparatus as claimed in claim 10 wherein said housing is affixed or adjacent magnet means.

12. The apparatus as claimed in claim 11 wherein said electromagnetic coil means is adjacent said housing.

13. The apparatus as claimed in claim 11 wherein said electromagnetic coil means is adjacent said piston.

14. The apparatus as claimed in claim 11 wherein said electromagnetic coil means is adjacent said piston.

15. The apparatus as claimed in claim 11 wherein said piston comprises said electromagnetic coil means.

16. The apparatus as claimed in claim 14 wherein said feed first gas and said feed second gas are common.

17. The apparatus as claimed in claim 16 further comprising heat exchanger means;
means for feeding a heat-source fluid to said heat exchanger means;
means for feeding a heat-receiving fluid to said heat exchanger to operably effect heat exchange with said heat-source fluid to produce a heated pressurized gas comprising a gas selected from the group consisting of said feed first gas, said feed second gas and combinations, thereof.

18. The apparatus as claimed in claim 17 wherein said pressurized gas has a pressure selected from 80 psi to 150 psi.

19. The apparatus as claimed in claim 18 wherein said first valve means and second valve means are synchronized to operably effect simultaneous first valve means opening with said second valve means closing, alternately, with first valve means closing with second valve means opening to effect continuous reciprocating piston movement cycles.

20. The apparatus as claimed in claim 19 wherein said synchronization control means comprises CPU control means.

21. The apparatus as claimed in claim 19 comprising a plurality of linear generator means in parallel.

22. The apparatus as claimed in claim 19 comprising a plurality of linear generator means in series.

23. The apparatus for electrical power generation as claimed in claim 1 comprising a housing having a cylindrical wall and a central longitudinal axis; a plurality of radial vanes within said housing operably rotatable around said central axis; said vanes with said wall define a plurality of chambers wherein each chamber has a wall portion; gas inlet and outlet means within each of said wall portions; valve means cooperable with each of said gas inlet and outlet means to operably control passage of a feed gas through each of said inlets into each of said chambers and spent gas through each of said gas outlets out of each of said chambers; magnet means and electromagnetic means cooperable with said, vanes whereby operable rotary movement of said vanes effects generation of electric current in said electromagnetic coil means.

24. The apparatus as claimed in claim 23 wherein each of said gas inlet and outlet means comprise inlet means and distinct outlet means.

25. The apparatus as claimed in claim 24 wherein said valve means comprises feed gas valve means and distinct spent gas valve means.

26. A method for producing an electric current by electromagnetic means comprising a plurality of chambers having gas inlet and outlet means and said method comprising
(a) (i) feeding a first pressurized gas to a first chamber of said electromagnetic means to provide a first pressure within said first chamber, with
(ii) synchronized releasing of a second pressurized gas from a second chamber to effect movement of said moveable member means to provide an electric current; subsequently
(b) (i) feeding a third pressurized gas to said second chamber of said electromagnetic means to provide said second pressure within said second chamber, with
(ii) synchronized releasing of said pressurized gas from said first chamber to effect movement of said moveable member means to provide an electric current; and
(c) subsequently repeating steps (a) and (b) to provide a continuous electric current.

27. The method as claimed in claim 26 wherein said electromagnetic means comprises a linear electromagnetic generator.

28. The method as claimed in claim 26 wherein said electromagnetic means is a radial electromagnetic generator.

29. The method as claimed in claim 28 further comprising controlling said feeding and said synchronized releasing by CPU algorithm software means.

30. An apparatus for generating electrical power, the apparatus comprising a power generating means: comprising magnetic field generating means and conductive member means, the magnetic field generating means and the conductive member means being adapted to move relative to each other so as to induce a current in the conductive member means, moving means for moving the magnetic field generating means and the conductive member means relative to each other, the moving means comprising: a pressurized fluid system providing a pressurized fluid to the power generating means, wherein the pressurized fluid is controlled via valve means to provide a controllable pressure difference across at least a part of the generator so as to move the magnetic field generating means and the magnetic member means relative to each other by forces generated by the pressure difference.

31. The apparatus according to claim 30 wherein the generator has a first port and a second port, and wherein the pressure difference is provided between the first port and the second port.

32. The apparatus according to claim 30 wherein the pressurized fluid impinge on the magnetic field generating means or the magnetic member means for generating a relative movement there between.

33. The apparatus according to claim 30 wherein the pressurized fluid system is guiding the pressurized fluid, the system further comprising: an inlet for providing a pressurized fluid to the system, and an outlet for letting the fluid exit the system, a first fluid line and a second fluid line for guiding said fluid, first switching means for switching said fluid between the first fluid line and the second fluid line, a first connection from the first fluid line to the. first port of the generator and a second connection from the second fluid line to the second port of the generator, second switching means positioned downstream of the generator for opening the outlet for the fluid in the first fluid line or for the fluid in the second fluid line, respectively, wherein the operation of the first switching means and the second switching means are synchronized to provide a pressure difference between the first port and the second port of the generator.

34. The apparatus according to claim 33 wherein the second switching means are opening the outlet for the fluid in the second fluid line when the first switching means are guiding the fluid to the first fluid line.
